(19) United States
(12) Patent Application Publication
(10) Pub. No.: US 2009/0120849 A1
(43) Pub. Date: May 14, 2009

(54) Apparatus for the Weight-Controlled Assembly of Products Into a Lot

(76) Inventors: Michael Jurs, Haffkrug (DE); Andreas Holzhuter, Lubeck (DE); Manfred Peters, Bad Schwatau (DE)

Correspondence Address: MATTINGLY, STANGER, MALUR & BRUNDIDGE, P.C., 1800 DIAGONAL ROAD, SUITE 370, ALEXANDRIA, VA, 22314, US

(21) Appl. No.: 11/814,968

(22) PCT Filed: Jan. 26, 2006
(86) PCT No.: PCT/EP2006/000851

§ 371 Date: Jul. 27, 2007

(30) Foreign Application Priority Data
Jan. 28, 2005 (DE) 10 2005 004 751.3

(51) Int. Cl. B07C 5/16; B07C 5/24

(52) U.S. Cl. 209/592; 209/646

(57) ABSTRACT

The invention concerns an apparatus for the weight-controlled assembly of products into a lot, including a delivery element (11) for delivering a plurality of unsorted products, a device (12) for separating the products, a removal element (13) for removing the separated products and a weighing device (14), which is distinguished by the fact that the device (12) includes several holding elements (18) and the weighing device (14) includes several elements (21) for weighing the separated products, each holding element (18) being assigned a element (21). Furthermore, the invention concerns a corresponding method.

The invention concerns an apparatus for the weight-controlled assembly of products into a lot, including a delivery element for delivering a plurality of unsorted products, a device for separating the products, a removal element for removing the separated products and a weighing device. Furthermore, the invention concerns a method for the weight-controlled assembly of products into a lot, including the steps of: delivering a plurality of unsorted products, separating the products, weighing the individual products, and assembling a lot.

In particular in the field of the packaging industry for foodstuffs, but also in other fields it is desirable and necessary to assemble individual lots from an unsorted batch, for example packaging lots consisting of several products, that is, packages e.g. with a given total weight. Packaging lots of this kind must meet different requirements. These requirements include by way of example in particular reaching a target or minimum weight on the one hand (amongst other things regulated by packaging regulations) and slight overfilling of the package on the other hand (economic interests of packaging plants). Further production influences such as e.g. unharmonious distribution of the weights of the products in the initial batch, a high yield of the apparatus and hygienic handling of the products are to be brought in line with filling, as assembly of the packaging lots is also called.

Specifically, it may for example be desirable to form a package having several fish fillets. The total weight of the package contents is to be 300 g, for example. The fillets attained from processing weigh e.g. approximately 50 g each, so that usually six of these fish fillets have to be assembled for one package or packaging lot. Naturally, the weights of the fish fillets vary. Some weigh more than 50 g, some weigh less. Simply assembling each packaging lot according to numbers would therefore possibly lead either to not achieving the minimum weight or overfilling the package. In order to find an optimum or a middle way between the different requirements and at the same time take the above-mentioned production parameters into consideration, the fish fillets are weighed and from a pool of several fish fillets are selected the six fish fillets which firstly reach the minimum weight and secondly minimise overfilling above the minimum weight.

Up to now, for this purpose the products have been separated from a random or unsorted batch. Separation can be done manually or by means of suitable handling apparatuses. The products delivered on a delivery element are taken off the delivery element by means of a gripper or by means of suction nozzles and deposited in another position on a removal belt. On the removal belt are then arranged the products which have been separated from a previously random/unsorted product stream. From this removal belt the products are then weighed before being assembled into a packaging lot. For this purpose the products are delivered to scales. After weighing the individual products, they are assembled to form the packaging lot with a given weight. Delivery to the scales and assembly of the lot can be done manually. Alternatively, the separated products can also be delivered to scales one after the other automatically and directly to a packaging lot. This known apparatus or the corresponding method, however, has the drawback that finally only the last position of a lot still to be allocated is available for optimising the total weight, as the other positions of a lot are established by already selected and allocated products. Furthermore, it may be that a fish fillet which cannot be allocated to any of the lots to be filled goes round several times, which limits the efficiency of the apparatus and so reduces the economic viability.

It is therefore the object of the present invention to propose a compact apparatus which guarantees optimised assembly of lots consisting of several products. Furthermore, it is the object of the invention to propose a corresponding method.

This object is achieved firstly by an apparatus with the features mentioned hereinbefore by the fact that the separating device includes several holding elements and the weighing device includes several elements for weighing the separated products, each holding element being assigned a weighing element. With this design it is possible in a simple and reliable manner to achieve automated assembly of optimised packaging lots. Automated handling also leads to a higher degree of hygiene being attained, as touching by hands is avoided. Furthermore, minor product overflow arises due to the construction according to the invention. Product overflow means in this connection that products which cannot be allocated are either completely discharged or delivered repeatedly to the cycle. The invention reduces this product overflow, leading to increased capacity and improved product quality.

Preferably, the elements for weighing the separated products and accordingly the holding elements are arranged in a ring on the outside round the delivery element. With this design, firstly a particularly compact and easy-to-handle apparatus is provided. Secondly, connection of the individual holding elements to supply pipes is particularly easy, which, apart from saving production costs, also leads to easy access to all components.

In a preferred development of the invention, the holding elements are on the one hand arranged stationarily on a frame and on the other hand designed to be movable for receiving a product from the delivery element and for discharging the product into the receptacle. This produces short transport distances which spare the product to be transported and minimise transport errors. Due to the mobility of the holding element, searching movements on the delivery element are possible. In other words, the holding element scans the area of the delivery element immediately in front of the associated receptacle in a kind of “snuffling movement”. This ensures reliable receipt of the product independently of the position of the product on the delivery element.

In a particularly preferred embodiment of the invention, all the holding elements, receptacles, elements for weighing the products and temporary stores are controlled separately. As a result, it is possible to assemble an optimum lot from a plurality of weighed products before it is delivered to a package or further production step.

Secondly, the object is achieved by a method with the steps mentioned hereinbefore by the fact that separation of the products and delivery of the separated products to a weighing device take place automatically, several separated products being temporarily stored separately and, knowing the individual weights, assembled into a lot having an optimum weight combination under the control of a program. Due to the parallel temporary storage of several products of known weight, the assembly of lots is improved because all positions of a lot can be chosen freely up to final filling, so that an optimum weight combination can be obtained. Automation leads to a reduction of manual effort, which in turn leads to cost savings.

Further preferred and advantageous features and embodiments as well as preferred method steps are apparent from the subsidiary claims and the description. A particularly preferred embodiment as well as the method are described in more detail with the aid of the attached drawings. The drawings show:

FIG. 1 a side view of a first embodiment of the apparatus according to the invention,

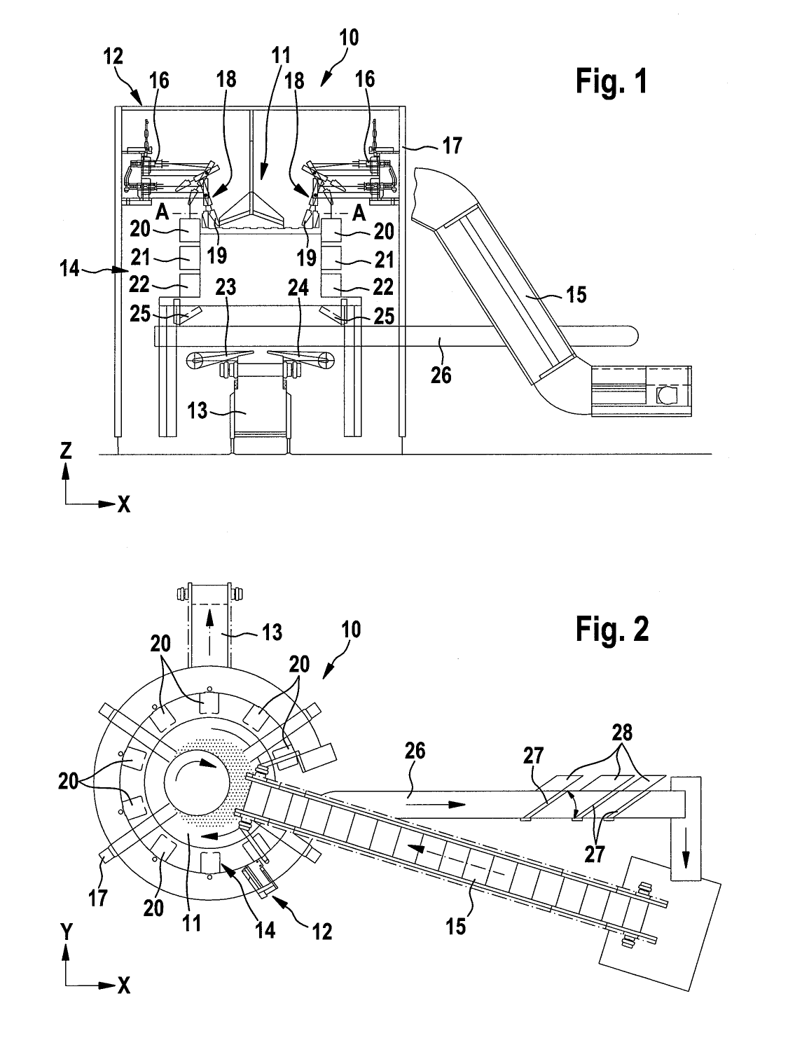

FIG. 2 a top view of the apparatus as in FIG. 1,

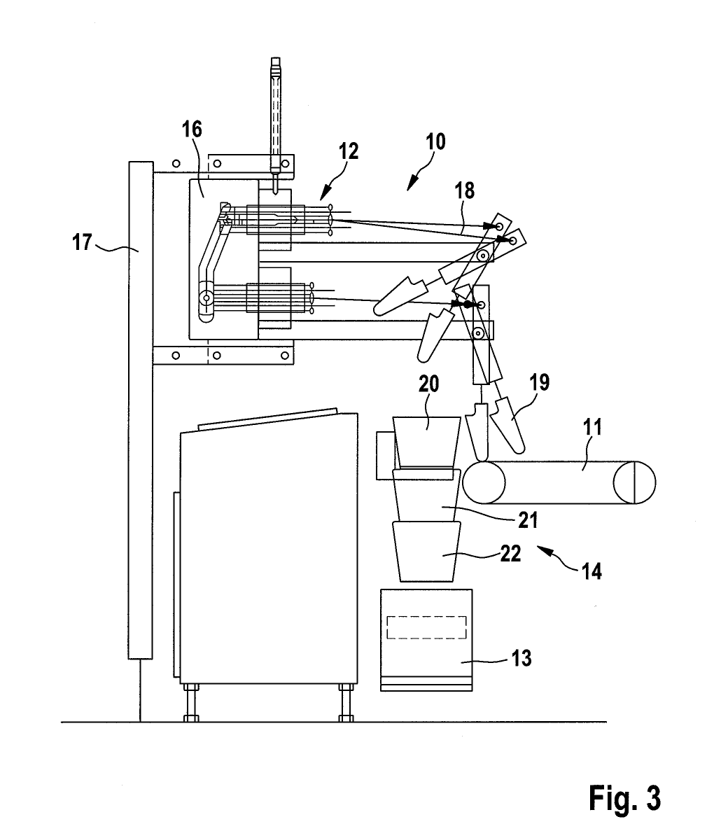

FIG. 3 a side view of a further embodiment of the apparatus according to the invention, and

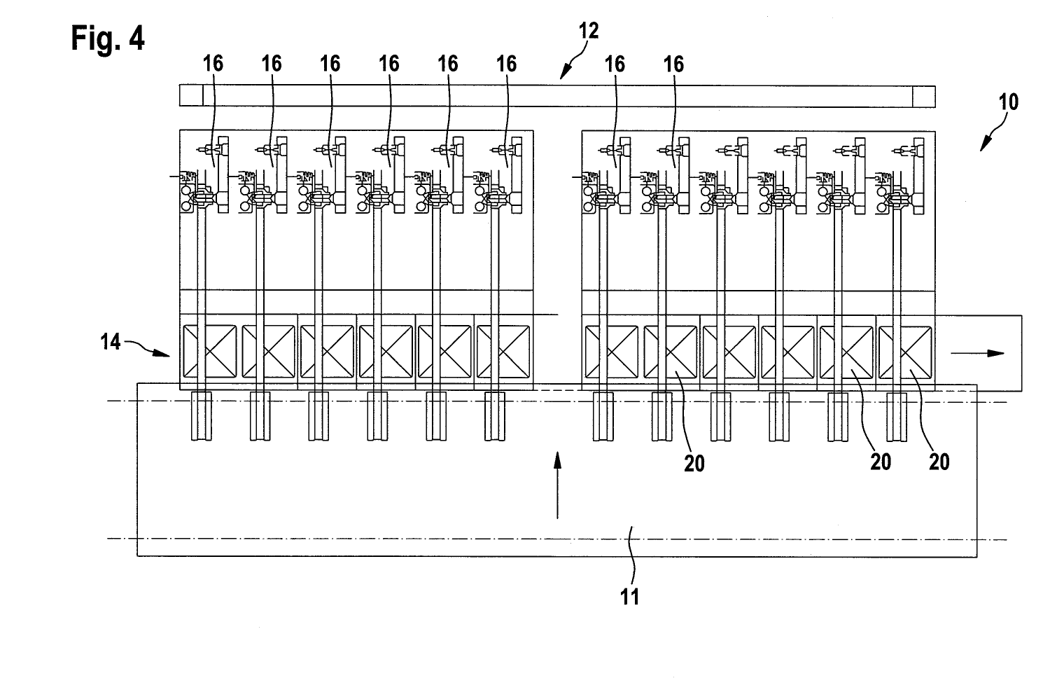

FIG. 4 a top view of the apparatus as in FIG. 3.

The apparatuses shown are used for the separation of products and weight-controlled assembly of the products into packaging lots or lots for further processing.

The apparatus 10 shown in FIG. 1 for the weight-controlled and weight-optimised assembly of products into a lot, in particular a packaging lot, essentially includes a delivery element 11 for delivering a plurality of unsorted and random products, a device 12 for separating the products, a removal element 13 for removing the separated products and a weighing device 14 for weighing the products.

The delivery element 11 is designed as a rotating storage table which is filled by a delivery belt 15 or the like and ensures continuous inflow of a product batch, that is, a plurality of unsorted and random products. However, the delivery element 11 can also be designed as a storage container, chute or in some other common way. The device 12 for separating the products is designed for taking the products off the delivery element 11, for holding the products during transport and for discharging the products to subsequent devices which will be described below. For this purpose the device 12 includes several units 16 which are mounted on a frame 17, stand or the like. The units 16 are preferably arranged stationarily at a fixed position of the frame 17 and distributed in a ring on the outside round the delivery element 11. The distance between the units 16 can vary, but is preferably evenly distributed over the circumference of the usually horizontally oriented delivery element 11, wherein a gap may be formed e.g. in the region in which the delivery belt 15 is provided.

Each unit 16 comprises a holding element 18. The holding elements 18 are preferably designed as suction nozzles 19 which are connected to a vacuum system (not shown). Gripping elements or a combination of mechanical gripping element and suction element may be used as well. The holding elements 18 with the suction nozzles 19 are movable for receiving a product from the delivery element 11, transport of the product over a receptacle 20 allocated to the holding element 18, and discharge of the product to the receptacle 20. The holding elements 18 have several degrees of freedom so that, within a plane, any points within range of the holding element 18 can be reached. The movement usually extends in a vertical plane, so that the suction nozzles 19 “scan” the delivery element 11 linearly in a radial direction. Control of the holding elements 18 can be mechanical e.g. by means of cam discs or the like, or also electronic.

Each holding element 18 or each suction nozzle 19 is allocated a receptacle 20 for receiving or depositing the product taken off the delivery element 11. Preferably each receptacle 20 is designed to receive a single product. The receptacles 20 are also arranged concentrically round the delivery element 11. Each receptacle 20 is to be opened for release of a product inside it and closed for receiving a further product. In the embodiment shown, opening and closing of the receptacles 20 are carried out by a hinged bottom flap. Other mechanisms for opening and closing the receptacles 20, for example sliding mechanisms or pivotable receptacles 20, can be used for receiving and discharging the products. In further embodiments the receptacles 20 can also have baffle plates or the like which are formed or arranged on the receptacles 20 on the side facing away from the delivery element 11.

Beneath each receptacle 20 is arranged an element 21 as part of the weighing device 14 for weighing a product. These elements 21 also have mechanisms (not shown) to be opened and closed so that, after weighing, the products can drop into a temporary store 22 located beneath each element 21. In other words, each holding element 18 is allocated a multi-stage arrangement on several levels of, from top to bottom, receptacle 20, element 21 and temporary store 22. The elements 21 can be designed separately for each receptacle 20 or be an integral part of the receptacle 20. There is also the possibility of using ordinary multiple-head scales, the number of heads corresponding to the number of receptacles 20.

Below the temporary stores 22 are arranged counter-driven conveyor belts 23, 24. By means of the conveyor belts 23, 24, the products assembled into a lot can then be delivered to the removal element 13. Below the temporary stores 22 and in front of the conveyor belts 23, 24 in the direction of dropping of the products can also be arranged pivotable flaps 25 which in their original position are pivoted into an upright, vertical position. In the original position the passage from the temporary store 22 to the conveyor belts 23, 24 is clear. If necessary, the flaps 25 are pivotable out of the original position into a horizontal discharge position. In the discharge position, the passage from the temporary stores 22 to the conveyor belts 23, 24 is blocked, so that the products dropping from the temporary stores 22 drop onto the flaps 25. All the flaps can be controlled and actuated separately. From the flaps 25, the products can be transferred by pivoting onto a subsequent conveyor 26.

Below the temporary stores 22 is arranged the conveyor 26. The conveyor 26 is ring-shaped in the region of the temporary stores 22 and leads away from the temporary stores 22 or the flaps 25 into the region of the delivery belt 15 or a collecting or storage receptacle. By means of a deflector 27, products can optionally be delivered back to the delivery belt 15 or to one or more collecting receptacles 28.

The whole apparatus 10 is connected to a control system (not shown). In other words, the apparatus 10 is program-controlled. By means of the control system, all the holding elements 18, receptacles 20, elements 21 and temporary stores 22 can be controlled separately. In particular, the temporary stores 22 can be controlled in such a way that several temporary stores 22 can be opened to form a lot of optimum weight, preferably at the same time, so that the products forming a lot can be moved out of several temporary stores 22 over the conveyor belts 23, 24 onto the removal element 13.

The apparatus 10 can be operated as a single apparatus or in line, for example with a filleting machine in front and followed by a packaging machine or the like. In addition to the design shown in FIGS. 1 and 2, in which the holding elements 18 are arranged in a ring round the delivery element 11, the holding elements 18 can also be arranged in line one behind the other, as shown in FIGS. 3 and 4. With a linear arrangement of holding elements 18 and elements 21, the individual stations (in each case consisting of holding element 18 and element 21) are connected to each other by a conveyor belt or the like as a delivery element 11. In variants of the apparatus 10, not shown explicitly, the weighing device 14 can also include only elements 21. This means that the receptacles 20, the temporary stores 22 and also the flaps 25 can be dispensed with, so that the products can be moved directly from the holding elements 18 onto the elements 21 and from the elements 21 onto the conveyor belts 23, 24.

Below, the method is described in more detail with regard to FIG. 1 with reference to the assembly of packaging lots for fish fillets:

an unsorted batch of fish fillets is delivered to the apparatus 10 for example via the delivery belt 15. The fish fillets have different weights. By means of the apparatus 10, the best possible combination of several fish fillets for a packaging lot is assembled, observing legal regulations for packages on the one hand and minimising overfilling on the other hand. For this purpose the fish fillets are first separated. From the delivery belt 15, the fish fillets drop onto the delivery element 11, namely the storage table. The storage table transports the fish fillets over and over on its path of rotation past the surrounding holding elements 18 or suction nozzles 19. The suction nozzles 19 move, optionally in contact with the delivery element 11 or without contact at a short distance from the delivery element 11, back and forth in a radial direction. In the process they can perform a movement exclusively in one direction, namely in the X direction, or in the X direction and in the Z direction, and so describe e.g. an undulating path. Due to this “snuffling”, the products moving past are detected, sucked up and picked up by means of the suction nozzles 19. As soon as a suction nozzle 19 has picked up a product, a vacuum switch indicates a vacuum and the suction nozzle 19 or holding element 18 receives the command to discharge the product into the associated receptacle 20. Thereby, it may be helpful for the product to impinge on a baffle plate during the movement towards the receptacle 20. As soon as the product is located above the receptacle 20, the product is dropped and stored in the receptacle 20. As long as the receptacle 20 is full, the holding element 18 stays in a standby position. However, the holding element 18 can also continuously scan the area to be reached by it. Optionally the holding element 18 or, to be more precise, the suction nozzle 19 can also be subjected to cleaning by rinsing, preferably outside the product region. There is also the possibility of it being determined by means of monitoring elements, not shown, whether, when a vacuum occurs, it is actually a product or only a particle of dirt or the like that has been sucked up. In the latter case, the holding element 18 can be moved into a cleaning position and subjected to cleaning.

From the receptacle 20, the product is then discharged to the element 21 lying underneath for weighing. As soon as the product has left the receptacle 20 in the direction of the element 21, the holding element 18 begins a searching movement again in order to suck up the next product with which the receptacle 20, which is empty again, can be filled. After weighing the product, it is passed into the temporary store 22 located under the element 21.

Knowingly the temporarily stored products or their weights, the computer-aided or program-aided control system assembles a lot of optimum weight. As soon as an ideal lot is assembled by computer, the products are released from the temporary stores 22 with the optimum weight combination or opened, so that the products of the determined lot drop onto the conveyor belts 23, 24 and then onto the removal element 13, and are there either delivered to a further production step or directly packaged as a lot. All the components are functionally connected to each other, so that periods of standing empty in the receptacles 20, the elements 21 and the temporary stores 22 are as short as possible. This means that, as soon as the product has been weighed and put in the temporary store 22, provided that the latter is free, the element 21 is filled with a new product from the receptacle 20 above. This control system is, however, variable as desired.

If products which do not match any lot due to their weight are weighed, these products can optionally be discharged and again delivered to the production flow or, knowing the weight, collected in individual fractions. For this purpose the flap 25 below the temporary store 22 concerned is moved into the discharge position. By opening the temporary store 22, the product drops onto the flap 25. By pivoting the flap into the original vertical position, the product drops onto the conveyor 26 which carries the product away. By means of the deflector 27 it can be selected whether the product is delivered to the delivery belt 15 again or to a collecting receptacle 28. According to the known weight of the discharged products, several of the receptacles 28 can also be filled.

Naturally, the method is similar for other products and/or other purposes, e.g. assembling lots for further processing in a subsequent step.

1-20. (canceled)

21. Apparatus for the weight-controlled assembly of products into a lot, including a delivery element for delivering a plurality of unsorted products, a device for separating the products, a removal element for removing the separated products and a weighing device, wherein the separating device includes several holding elements designed as suction nozzles and the weighing device includes several elements for weighing the separated products, each holding element being assigned a suction nozzle, and the elements and accordingly the associated suction nozzles being arranged in a ring on the outside round the delivery element, and in that the suction nozzles are on the one hand arranged stationarily on a frame and on the other hand designed to be movable for receiving a product from the delivery element and for discharging the product to a element.

22. Apparatus according to claim 21, wherein the delivery element is a circular storage table.

23. Apparatus according to claim 21, wherein above each element is arranged a receptacle for receiving an individual product still to be weighed, and below each element is arranged a temporary store for receiving a product already weighed.

24. Apparatus according to claim 23, wherein each receptacle has a bottom flap or the like to be opened and closed.

25. Apparatus according to claim 21, wherein the apparatus is connected to a control system.

26. Apparatus according to claim 25, wherein all the holding Elements, receptacles, elements and temporary stores can be controlled separately.

27. Apparatus according to claim 23, wherein the temporary stores can be controlled in such a way that several temporary stores can be opened to form a lot of optimum weight, so that the products forming a lot can be moved out of several temporary stores onto the removal element.

28. Apparatus according to claim 23, wherein beneath each temporary store are arranged elements for discharging unwanted products.

29. Apparatus according to claim 22, wherein above each element is arranged a receptacle for receiving an individual product still to be weighed, and below each element is arranged a temporary store for receiving a product already weighed.

30. Apparatus according to claim 22, wherein the apparatus is connected to a control system.

31. Apparatus according to claim 23, wherein the apparatus is connected to a control system.

32. Apparatus according to claim 24, wherein the apparatus is connected to a control system.

33. Apparatus according to claim 24, wherein the temporary stores can be controlled in such a way that several temporary stores can be opened to form a lot of optimum weight, so that the products forming a lot can be moved out of several temporary stores onto the removal element.

34. Apparatus according to claim 25, wherein the temporary stores can be controlled in such a way that several temporary stores can be opened to form a lot of optimum weight, so that the products forming a lot can be moved out of several temporary stores onto the removal element.

35. Apparatus according to claim 26, wherein the temporary stores can be controlled in such a way that several temporary stores can be opened to form a lot of optimum weight, so that the products forming a lot can be moved out of several temporary stores onto the removal element.

36. Apparatus according to claim 24, wherein beneath each temporary store are arranged elements for discharging unwanted products.

37. Apparatus according to claim 25, wherein beneath each temporary store are arranged elements for discharging unwanted products.

38. Apparatus according to claim 26, wherein beneath each temporary store are arranged elements for discharging unwanted products.

39. Apparatus according to claim 27, wherein beneath each temporary store are arranged elements for discharging unwanted products.
